(19) United States
(12) Patent Application Publication
(10) Pub. No.: US 2025/0023959 A1
(43) Pub. Date: Jan. 16, 2025

(54) Programmable Multi-Protocol Adapter for Integrated Circuit

(71) Applicants: Hsinho Wu, Santa Clara, CA (US); Masashi Shimanouchi, San Jose, CA (US); Peng Li, Palo Alto, CA (US)

(72) Inventors: Hsinho Wu, Santa Clara, CA (US); Masashi Shimanouchi, San Jose, CA (US); Peng Li, Palo Alto, CA (US)

(21) Appl. No.: 18/900,217

(22) Filed: Sep. 27, 2024

(51) Int. Cl. H04L 69/18

(52) U.S. Cl. CPC H04L 69/18

(57) ABSTRACT

Integrated circuit devices, methods, and circuitry to enable a higher-power transceiver to comply with a lower-power protocol. An integrated circuit system may include a first transceiver to operate using a first protocol and multi-protocol adapter circuitry. The multi-protocol adapter circuitry may be configurable to enable the first transceiver to be compliant with a second protocol that is a lower-power protocol than the first protocol.

### BACKGROUND

This disclosure relates to a programmable adapter to support multiple protocols that may include programmable pulse width modulation (PWM), state-dependent input-output (I/O) impedance, edge rate, and/or voltage transfer for communication between integrated circuits.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art

Integrated circuits are found in numerous electronic devices and provide a variety of functionality. Different integrated circuits may use different communication protocols. For example, many high-performance integrated circuits may use a communication protocol that uses relatively high frequencies and is highly robust. Other integrated circuits may use a communication protocol that is more power efficient, but which uses lower frequency and/or more sensitive to particular specifications. Many high-performance integrated circuits, such as programmable logic devices that include field programmable gate array (FPGA) circuitry, are used to test a variety of integrated circuits devices. However, many FPGA transceivers are not fully compatible with lower-power communication protocols.

### BRIEF DESCRIPTION OF THE DRAWINGS

Various aspects of this disclosure may be better understood upon reading the following detailed description and upon reference to the drawings in which:

FIG. 1 is a block diagram of a system to enable communication between two integrated circuit devices with different communication protocols using multi-protocol adapter circuitry controlled by adapter controller logic circuitry of the first integrated circuit device;

FIG. 2 is a block diagram of a system to enable communication between two integrated circuit devices with different communication protocols using in-package multi-protocol adapter circuitry;

FIG. 3 is a block diagram of a system to enable communication between two integrated circuit devices with different communication protocols using multi-protocol adapter circuitry formed as part of a monolithic implementation of one of the integrated circuit devices;

FIG. 4 is a block diagram of a system to enable communication between two integrated circuit devices with different communication protocols using multi-protocol adapter circuitry incorporated into a transceiver of the first integrated circuit device;

FIG. 5 is a block diagram of a system to enable communication between two integrated circuit devices with different communication protocols using multi-protocol adapter circuitry controlled by adapter controller circuitry of an application specific integrated circuit (ASIC) of a package of the first integrated circuit device;

FIG. 6 is a block diagram of a system to enable communication between two integrated circuit devices with different communication protocols using multi-protocol adapter circuitry controlled by adapter controller circuitry of an application specific integrated circuit (ASIC) on the board of the first integrated circuit device;

FIG. 7 is a block diagram of a system to enable communication between two integrated circuit devices with different communication protocols using multi-protocol adapter circuitry controlled by adapter controller circuitry of an application specific integrated circuit (ASIC) on the board of the second integrated circuit device;

FIG. 8 is a block diagram illustrating circuitry of the multi-protocol adapter circuitry to control impedance at a transmitter of the first integrated circuit device;

FIG. 9 is a block diagram illustrating circuitry of the multi-protocol adapter circuitry to control impedance at a receiver of the first integrated circuit device;

FIG. 10 is a block diagram illustrating circuitry of the multi-protocol adapter circuitry including bypassable edge converter circuitry to comply with rise/fall time or edge rate specifications at the first integrated circuit device;

FIG. 11 is a block diagram illustrating circuitry of the multi-protocol adapter circuitry to control attenuation so that a higher-power transmitter of the first integrated circuit device is compatible with a lower-power transmitter of the second integrated circuit device;

FIG. 12 is a block diagram illustrating circuitry of the multi-protocol adapter circuitry to control a common mode voltage of a transmitter of the first integrated circuit device to be compatible with 50 ohm to ground termination of a transmitter of the second integrated circuit device;

FIG. 13 is a block diagram illustrating circuitry of the multi-protocol adapter circuitry to control a common mode voltage of a transmitter of the first integrated circuit device to be compatible with 100 ohm differential termination of a transmitter of the second integrated circuit device;

FIG. 14 is a block diagram illustrating circuitry of the multi-protocol adapter circuitry including a power splitter/combiner to enable a direct current (DC)-coupled transmitter of the second integrated circuit device to communicate with an alternating current (AC)-coupled receiver of the second integrated circuit device; and

FIG. 15 is a block diagram of a data processing system that may incorporate the multi-protocol adapter circuitry.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

Many integrated circuit devices, such as field programmable gate arrays (FPGAs) are in demand to support flexible and low power consumption protocols various applications, such as mobile and storage device product development and testing. Increasingly, these devices are using lower-power protocols, such as MIPI M-PHY. The MIPI M-PHY protocol is a serial communication protocol for use in mobile systems where performance, power, and efficiency are key criteria. It is the foundation for several upper layer protocols that manage complex data transfer functions. To achieve certain performance, power, and efficiency objectives, M-PHY defines low-speed and high-speed modes with both pulse-width modulation (PWM) and Non-Return-to-Zero (NRZ) or Pulse Amplitude Modulation 4-Level (PAM4) modulation, as well as specific electrical characteristics or features that are not commonly seen in high-speed serial communication links often used by FPGA devices.

Multi-protocol adapter circuitry may enable communication between higher-power transceivers and lower-power transceivers. The multi-protocol adapter circuitry may include programmable pulse width modulation (PWM), state-dependent input/output (I/O) impedance, edge rate, and voltage transfer. For example, the multi-protocol adapter circuitry may enable a higher-power transceiver to communicate with devices with flexible and lower-power protocols such as M-PHY. The multi-protocol adapter of this disclosure may enable seamless communication, causing the integrated circuit device using the higher-power transceiver to appear to be another M-PHY device, while using a single transceiver and supporting both PWM and NRZ/PAM4 modulations. Indeed, the multi-protocol adapter circuitry of this disclosure may support M-PHY communications for all modes and modulations, such as hibernation, low-speed, high-speed, PWM, and NRZ/PAM4, using a single higher-power transceiver for each M-PHY line. The multi-protocol adapter may also benefit from the programmable nature of FPGAs. The multi-protocol adapter may be programmed in accordance with application specifications. This is particularly useful because M-PHY is a versatile protocol with many optional features. Moreover, there may be many other lower-power protocols that may be generally incompatible with higher-power protocols supported by higher-power, higher-frequency transceivers. The multi-protocol adapter circuitry of this disclosure may enable such higher-power, higher-frequency transceivers to be compatible with lower-power transceivers that use lower-power protocols. The following disclosure uses the M-PHY protocol as an example of such a lower-power protocol.

Lower-power communication protocols, such as M-PHY, may have a number of detailed specifications. For example, the M-PHY protocol may support multiple types of physical media attachment modules. With a Type-I module, which is the dominant M-PHY usage type, an M-PHY transceiver is specified to support both low-speed and high-speed modes, as well as PWM and NRZ/PAM4 modulations. An M-PHY transceiver is also specified to extendedly change impedance at different times to achieve power saving by idling/stalling the M-PHY transceivers when there is no data transmission. Yet a higher-power transceiver may not be compatible or compliant with the M-PHY protocol. Many higher-power transceivers may lack specified M-PHY capabilities for power saving operations in the following areas:
PWM operation: PWM operation is specified by the M-PHY protocol for low-speed data transmission.
Impedance control: The M-PHY protocol specifies transmitters and receivers to control their impedances in various data transmission modes, changing in higher-speed, lower-speed, and power-saving modes, such as data burst and sleep/stall/hibernation states.
Signal rise/fall times: The M-PHY protocol is commonly used in mobile devices, so signal rise/fall times are strictly specified to ensure EMI compliance.
Common mode voltage and signal amplitude ranges: The M-PHY protocol specifies transmitter output common mode voltage and signal amplitude ranges that may not match higher-power transceivers.

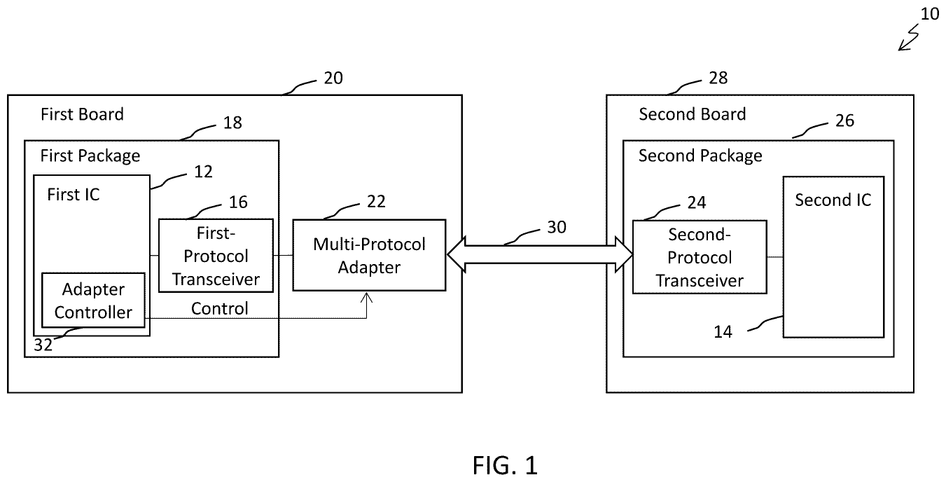

FIG. 1 illustrates a communication system 10 to enable communication between a first integrated circuit (IC) 12 and a second IC 14. In one example, the first IC 12 may be a testing device and the second IC 14 may be a device under test (DUT). There may be many situations in product development where a product under development (e.g., the second IC 14) may be tested (e.g., by the first IC 12) to ensure proper operation. In such a testing scenario, the first IC 12 may be a programmable logic device (PLD), such as a field programmable gate array (FPGA), or may be an application specific integrated circuit (ASIC). Additionally or alternatively, the first IC 12 may include a processor (e.g., central processing unit (CPU), graphics processing unit (GPU)), artificial intelligence (AI) compute circuitry, memory or storage (e.g., random access memory (RAM), read only memory (ROM), nonvolatile memory, high-bandwidth memory (HBM)), or the like.

The first IC 12 may communicate using a first-protocol transceiver 16. In the example of FIG. 1, the first IC 12 and the first-protocol transceiver 16 are separate dies in a first package 18 on a first printed circuit board 20. In other examples, the first IC 12 and the first-protocol transceiver 16 may be part of a single monolithic integrated circuit. Multi-protocol adapter circuitry 22 may enable the first-protocol transceiver to send communication to or receive communication from a second-protocol transceiver 24 in communication with the second IC 14. In the example of FIG. 1, these are separate dies in a second package 26 on a second printed circuit board 28. In other examples, the second IC 14 and the second-protocol transceiver 24 may be part of a single monolithic integrated circuit.

The first-protocol transceiver 16 and the second-protocol transceiver 24 may operate according to different communication protocols. For example, the first-protocol transceiver 16 may be able to communicate using a variety of different high-speed, higher-power protocols, whereas the second-protocol transceiver 24 may operate according to a lower-power protocol. In one example, the second-protocol transceiver 24 may operate according to the Mobile Industry Processor Interface (MIPI) M-PHY protocol. The multi-protocol adapter circuitry 22 may provide an interface between the first-protocol transceiver 16 and the second-protocol transceiver 24 to emulate the lower-power protocol from the perspective of the second-protocol transceiver 24. A communication link 30 may include transmission lines from the first-protocol transceiver 16 to the second-protocol transceiver 24 and/or transmission lines from the second-protocol transceiver 24 to the first-protocol transceiver 16.

An adapter controller 32 may control the operation of the multi-protocol adapter circuitry 22. The adapter controller 32 may issue Control signals to cause the multi-protocol adapter circuitry 22 to perform different operations that emulate the lower-power protocol of the second-protocol transceiver 24. These operations may include adjusting transmitted or received signals to provide programmable pulse width modulation (PWM), state-dependent input/output (I/O) impedance, edge rate, and voltage transfer to enable the first-protocol transceiver 16 to comply with the second, lower-power protocol. In FIG. 1, the adapter controller 32 may be implemented on the first IC 12 (e.g., as a finite state machine (FSM), a program running on a processor of the first IC 12). In one example, the adapter controller 32 is an intellectual property (IP) module implemented in programmable logic circuitry of the first IC 12.

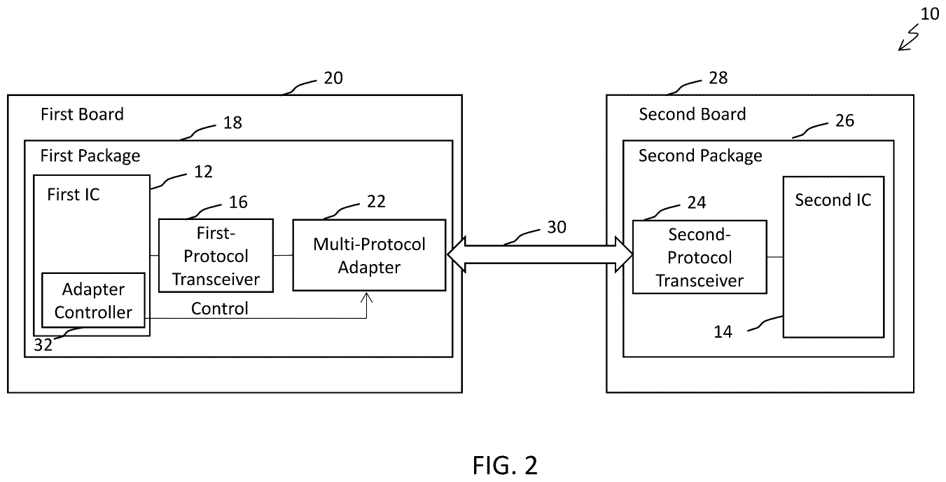

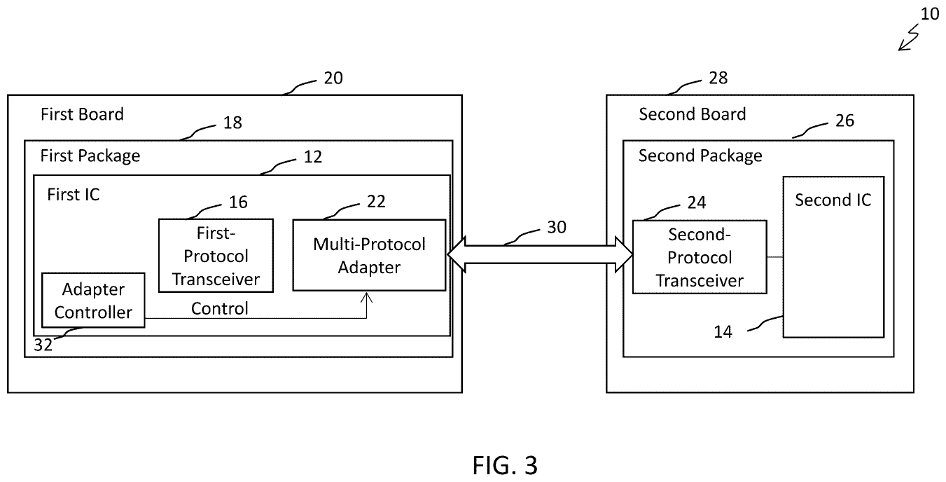

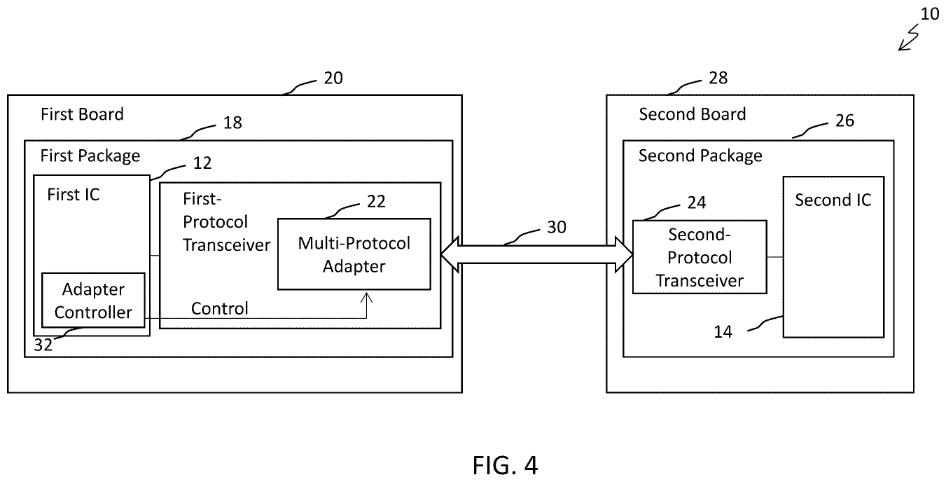

The multi-protocol adapter circuitry 22 may be disposed in any circuitry between the first-protocol transceiver 16 and the second-protocol transceiver 24. In FIG. 1, the multi-protocol adapter circuitry 22 is separate circuitry on the first printed circuit board 20 (e.g., circuitry disposed on or part of the printed circuit board 20, a separate integrated circuit die). In FIG. 2, the multi-protocol adapter circuitry 22 is an integrated circuit die within the same first package 18 as the first IC 12 and the first-protocol transceiver 16. In FIG. 3, the first IC 12 is a monolithic die that includes the first-protocol transceiver 16, the multi-protocol adapter circuitry 22, and the adapter controller 32. In FIG. 4, the multi-protocol adapter circuitry 22 is circuitry that is part of the first-protocol transceiver 16.

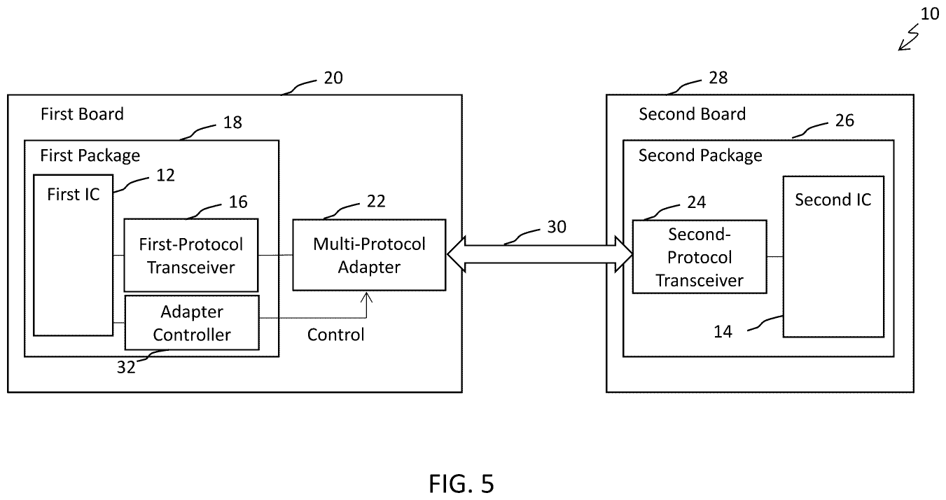

In other examples, the adapter controller 32 may be disposed elsewhere. For example, as shown in FIG. 5, the adapter controller 32 is a separate integrated circuit die (e.g., a separate ASIC) within the same first package 18 as the first IC 12 and the first-protocol transceiver 16. In FIG. 6, the adapter controller 32 separate circuitry on the first printed circuit board 20 (e.g., circuitry disposed on or part of the printed circuit board 20, a separate integrated circuit die).

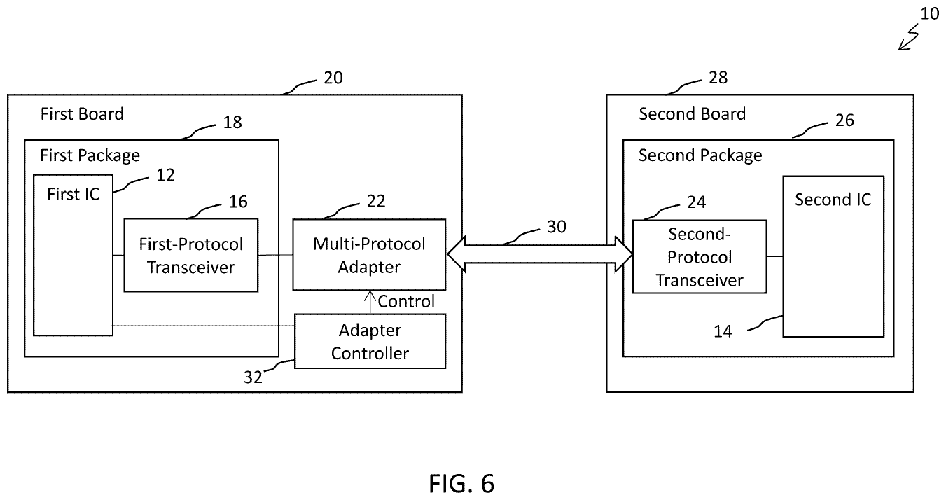

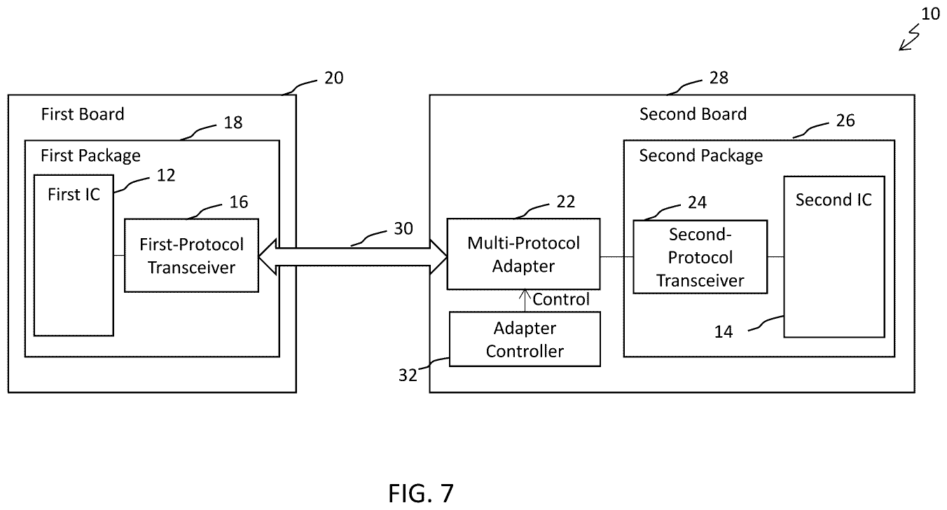

In some cases, such as shown in FIG. 7, the multi-protocol adapter circuitry 22 may be disposed on the second printed circuit board 28 (e.g., as circuitry disposed on or part of the printed circuit board 28, as an integrated circuit die that may be installed on the second printed circuit board 28). In this way, the second printed circuit board 28, acting as a test board, may be installed with the multi-protocol adapter circuitry 22 to enable a device under test using a lower-power protocol to be tested. The adapter circuitry 32 may be disposed on the second printed circuit board 28 as shown in FIG. 7, or may be disposed in any other suitable location (e.g., as illustrated in FIGS. 1-6). For example, the multi-protocol adapter circuitry 22 shown in FIG. 7 may receive control signals over the communication link 30 from the first IC 12 or via one or more input pins via the second printed circuit board 28.

### PWM Emulation by Oversampling

The higher-power first-protocol transceiver 16 may emulate the lower-power second protocol of the second-protocol transceiver 24 by oversampling. For example, the lower-power M-PHY protocol specifies the use of pulse width modulation (PWM) for low-speed communication. For PWM with data rate of X Mbps, a transmitter of the first-protocol transceiver 16 may be configured to generate an NRZ signal at Y Mbps. For some lower-power protocols, such as M-PHY, Y is ≥20X. On this basis, the transmitter of the first-protocol transceiver 16 may then oversample the data payload to produce the PWM signal that is expected by a receiver of the second-protocol transceiver 24. The ≥20 oversampling rate may be chosen so that the first-protocol transceiver 16 can meet the PWM transmit ratio specification (˜5%) specified by M-PHY. The first-protocol transceiver 16 may be a general-purpose high-speed FPGA transceiver. With FPGA general purpose (e.g., wide data rate range) transceivers, the oversampling rate may be programmed to emulate M-PHY PWM operations from PWM-G1 (3˜9Mbps) to >PWM-G7(>500 Mbps) rates.

### Impedance Control

A lower-power protocol may specify different impedances at different times to save power. For example, the M-PHY protocol specifies that an M-PHY transmitter and receiver operate with defined impedance (or termination) levels to support both power-saving as well as high-speed data transmission. These specified settings are provided in the tables below:

| Differential | | | | |
|---|---|---|---|---|
| LINE | M-TX Output | M-RX Input | LINE State | LINE |
| Voltage | Impedance | Impedance | Set by | State Name |
| Positive | Low | Any | M-TX | DIF-P |
| Negative | Low | Any | M-TX | DIF-N |
| Zero | High | Medium | M-RX | DIF-Z |
| Unknown or | High | High | None | DIF-Q |
| floating | | | | |

| Imped. | Value | Usage |
|---|---|---|
| TX Low | 50 Ω (SE, typ) | HS-MODE |
| TX High | 10 kΩ (SE, max) | HIBERN8 |
| RX Medium | >100 Ω (diff, typ) | HIBERN8 |
| RX High | 10 kΩ (diff, min) | LS-MODE |
| RX Any | RX High or 100 Ω | HS/LS-MODE |

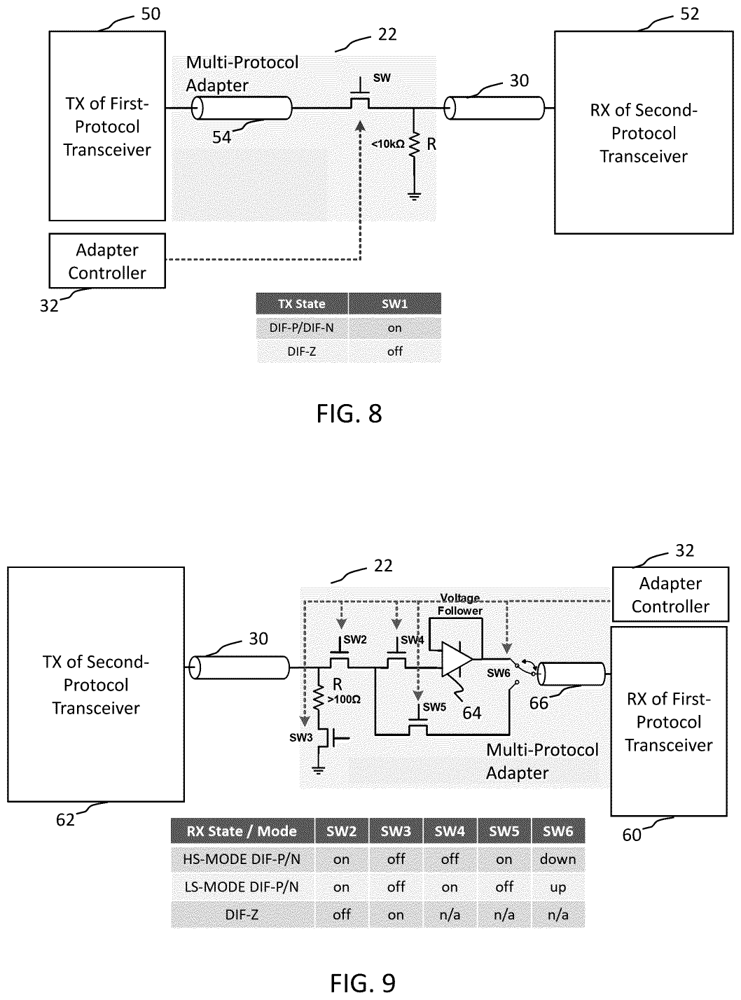

As shown in FIG. 8, the multi-protocol adapter circuitry 22 may provide impedance control for a first-protocol transmitter 50 of the first-protocol transceiver 16. Indeed, from the perspective of a second-protocol receiver 52 of the second-protocol transceiver 24, the first-protocol transmitter 50 of the first-protocol transceiver 16 will appear to have an impedance in compliance with the lower-power protocol. As such, the multi-protocol adapter circuitry 22 may effectively bring the first-protocol transmitter 50 of the first-protocol transceiver 16 into compliance with the lower-power protocol of the second-protocol transceiver 24. To provide impedance control, the multi-protocol adapter circuitry 22 may include a resistor R and a switch SW1. To support M-PHY, the resistor may have a resistance of about 10 kΩ, though to support other lower-power protocols, the resistor R may have a different resistance. The adapter controller 32 may control the switch SWI closed in a transmission line state of differential positive (DIF-P) or differential negative (DIF-N) with an impedance equal to the impedance of an input transmission line 54 (e.g., the impedance of an input into the multi-protocol adapter circuitry 22 from the first-protocol transmitter 50). The adapter controller 32 may control the switch SWI open in a transmission line state of differential zero (DIF-Z) with an impedance of the resistor R.

The multi-protocol adapter circuitry 22 may also provide impedance control for a first-protocol receiver 60 of the first-protocol transceiver 16, as shown in FIG. 9. Indeed, from the perspective of a second-protocol transmitter 62 of the second-protocol transceiver 24, the first-protocol receiver 60 of the first-protocol transceiver 16 will appear to have an impedance in compliance with the lower-power protocol. As such, the multi-protocol adapter circuitry 22 may effectively bring the first-protocol receiver 60 of the first-protocol transceiver 16 into compliance with the lower-power protocol of the second-protocol transceiver 24. To provide impedance control for the first-protocol receiver 60, the multi-protocol adapter circuitry 22 may include a resistor R having a resistance of over 100 Ω and switches SW2, SW3, SW4, SW5, and SW6. The adapter controller 32 may control the switches SW2 and SW4 on (closed), SW3 and SW5 off, and SW6 up in a low-speed (LS)-mode DIF-P/N state. This may cause a low-power signal received on an input of the multi-protocol adapter 22 at the communication link 30 to be amplified through an amplifier 64 before reaching a transmission line 66 at an output of the multi-protocol adapter circuitry 22 into the first-protocol receiver 60. The adapter controller 32 may control the switches SW2 and SW5 on (closed), SW3 and SW4 off (open), and SW6 down in a high-speed (HS)-mode DIF-P/N state. The adapter controller 32 may control the switches SW3 on (closed) and SW2 off (open) in a DIF-Z state.

### Bypassable Edge Converter

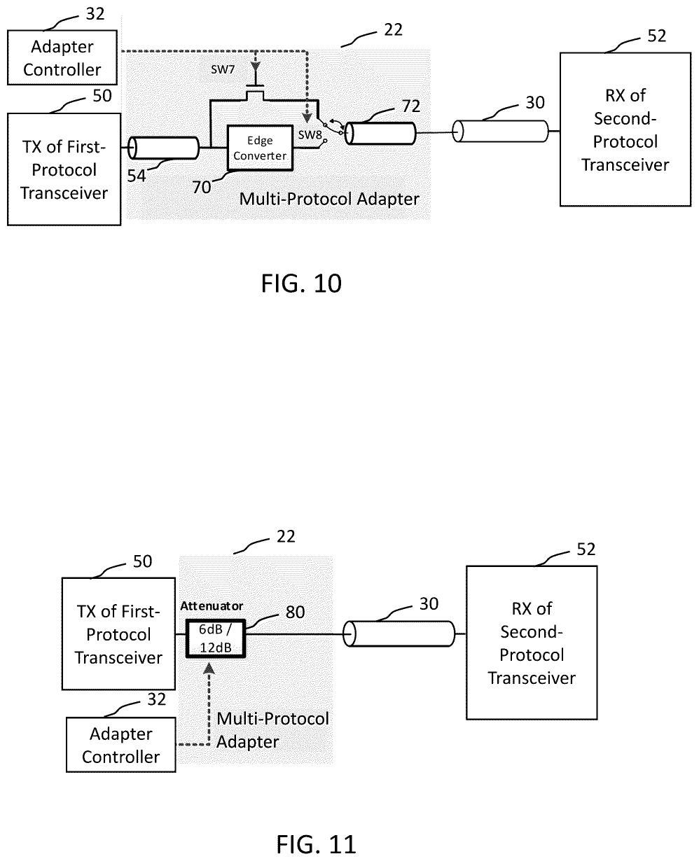

A lower-power protocol, such as M-PHY, may specify rise or fall times or the edge rate of the signal to reduce electromagnetic interference (EMI). As such, as shown in FIG. 10, the multi-protocol adapter circuitry 22 may include an edge converter 70 that may be selected or bypassed based on switches SW7 and SW8. The adapter controller 32 may control the switch SW7 off (open) and the switch SW8 down to cause the signal received from the first-protocol TX 50 on the input transmission line 54 to enter the edge converter 70. The edge converter 70 may perform edge rate control or may convert one type of signal edge or transition to another to enable compliance with the lower-power protocol. The adapter controller 32 may control the switch SW7 on (closed) and the switch SW8 up to cause the signal from the input transmission line 54 to bypass the edge converter 70 out to an output transmission line 72 of the multi-protocol adapter circuitry 22. In either case, the resulting signal may be output onto the link 30. From the perspective of the second-protocol receiver 52, the received signal may comply with the lower-power protocol used by second-protocol receiver 52.

### Attenuator for Voltage Transfer

A lower-power protocol, such as M-PHY, may use lower-voltage signals than output by the first-protocol transceiver 16. As such, as shown in FIG. 11, the multi-protocol adapter circuitry 22 may include a programmable attenuator 80 to transfer common voltage and signal amplitude. The adapter controller 32 may control the programmable attenuator 80 to attenuate the signal received from the first-protocol transmitter 50 by some specified amount (e.g., 0 decibels (dB), 6 dB, 12 dB). This may effectively reduce the voltage to the lower voltage that is expected by the second-protocol receiver 52. Thus, from the perspective of the second-protocol receiver 52, the received signal may comply with the lower-power protocol used by the second-protocol receiver 52.

### Power Splitter/Combiner to Adjust TX Common Mode Voltage

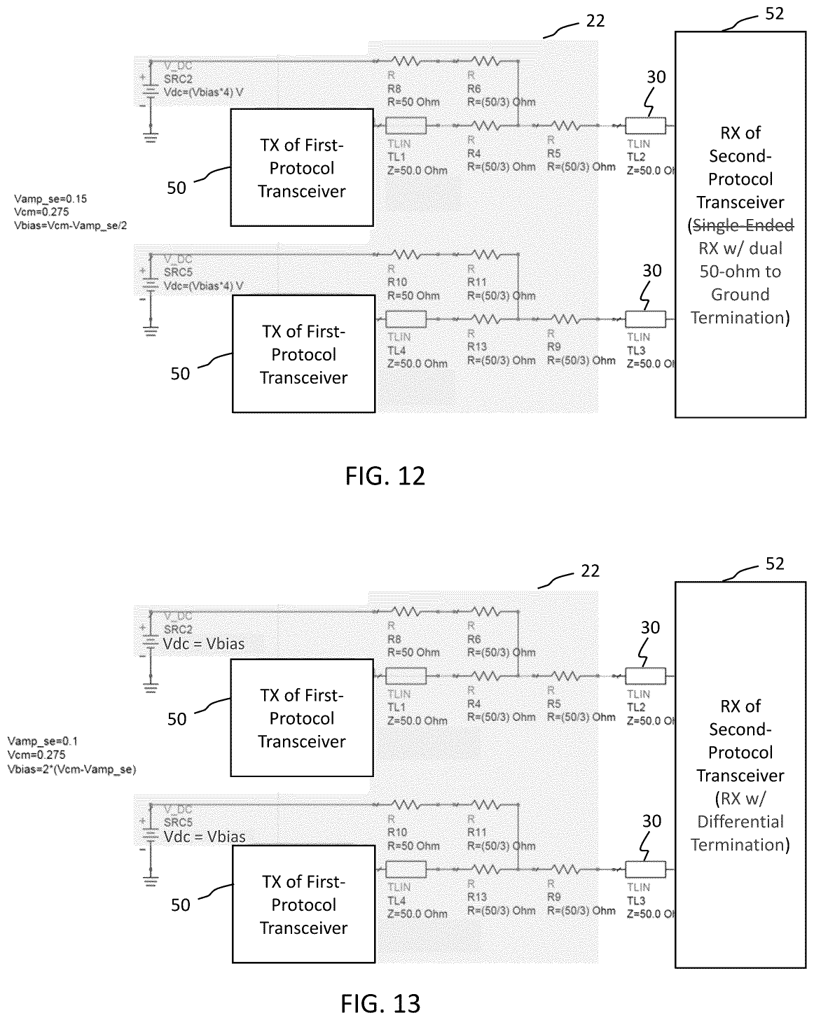

Some transmitter designs for the first-protocol transmitter 50 may use variable and/or low common mode voltage (Vcm) levels. As such, as shown in FIGS. 12 and 13, a power splitter/combiner scheme may adjust Vcm to meet application parameters. The multi-protocol adapter circuitry 22 may enable one first-protocol transmitter 50 to communicate over a single-ended terminal of the second-protocol receiver 52 (FIG. 12) or may enable two first-protocol transmitters 50 to communicate over two differential terminals of the second-protocol receiver 52 (FIG. 13). The multi-protocol adapter circuitry 22 may include a number of resistors R4, R5, R6, R8, R9, R10, R11, and R13, transmission lines TL1, and TL4, and voltage sources SRC2 and SRC5 to supply a direct current (DC) voltage Vdc. The communication link 30 may include transmission lines TL2 and TL3. The transmission lines TL1, TL2, TL3, and TL4 may all have impedances of 50 Ω. Resistors R8 and R10 may have impedances of 50 Ω, while resistors R4, R5, R6, R9, R11, and R13 may have impedances of (50/3) Ω.

The circuitry shown in FIGS. 12 and 13 may be used with transmitters with current mode drivers or voltage mode drivers. The voltage supply level (Vdc in FIGS. 12 and 13) can be determined based on three factors: 1) Target common mode voltage (Vom in FIGS. 12 and 13) of the communication link 30, 2) Target transmitter output amplitude (Vamp_se in FIGS. 12 and 13), and 3) Receiver termination type (differential termination or terminated to ground).

FIG. 12 represents an example of a receiver with dual 50 ohm to ground terminations. Here, the single-ended amplitude Vamp_se may be equal to 0.15V, the common mode voltage Vcm may be equal to 0.275V, and a bias voltage Vbias may be equal to Vcm−(Vamp_se/2). The Vdc supplied by the voltage sources may be equal to (Vbias*4). This results in a proper common mode voltage Vcm while using the first-protocol transmitters 50 to communicate with single-ended terminals of the second-protocol receiver 52 independently.

FIG. 13 represents an example of differential transmission. Here, the single-ended amplitude Vamp_se may be equal to 0.1V, the common mode voltage Vom may be equal to 0.275V, and a bias voltage Vbias may be equal to 2*(Vcm−Vamp_se). The Vdc supplied by the voltage sources may be equal to Vbias. This results in a proper common mode voltage Vom while using the first-protocol transmitters 50 to communicate with differentially connected terminals of the second-protocol receiver 52.

### Power Splitter/Combiner to Adjust RX Common Mode Voltage

Many higher-power receivers are intended for AC-coupled communication links, which is common for many high-speed serial link receivers where they can be far away from the transmitters from which the receivers are receiving signals. Moreover, many higher-power receiver designs may have different process nodes or architectures and are designed to operate at certain common mode voltage (Vcm) or bias voltage for efficiency and performance reasons. To work with M-PHY transmitters in a DC-coupled communication link configuration, a power splitter/combiner scheme has been developed that can shift the transmitter or communication link common mode voltage (Vcm) to a desired or optimal Vcm or bias voltage level of the receiver.

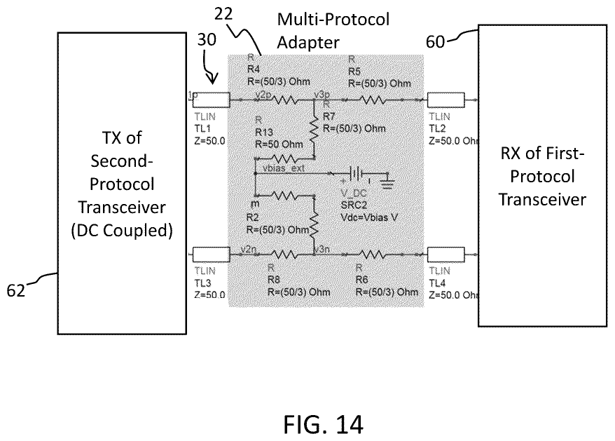

FIG. 14 provides an example of circuitry that may be included in the multi-protocol adapter circuitry 22 to enable a DC-coupled communication link from the second-protocol transmitter 62 to be adapted for a first-protocol receiver 60. Note that, in some embodiments, an on-die AC-coupling capacitor in the first-protocol receiver 60 may be bypassed to enable the lower-power protocol (e.g., M-PHY) operations. In the example of FIG. 14, the communication link 30 includes transmission lines TL1 and TL3 with 50-ohm, for example, characteristic impedance and the first-protocol receiver 60 includes transmission lines TL2 and TLA with 50-ohm, for example, characteristic impedance. The multi-protocol adapter circuitry 22 may include a DC voltage source SRC2 and resistors R2, R4, R5, R6, R7, R8, and R13. The resistor R13 may be 5002 and the resistors R2, R4, R5, R6, R7, and R8 may be (50/3) Ω. The voltage Vbias, which is used to adjust/control the incoming Vcm into the first-protocol receiver 60, can be determined by two factors: 1) the intended Vom for the receiver; and 2) the transmitter output voltage. By selecting the voltage Vbias to provide via the voltage source SRC2, an AC-coupled higher-power transmitter (e.g., the first-protocol receiver 60) may effectively comply with a lower-power protocol (e.g., M-PHY) used by a lower-power transmitter (e.g., the second-protocol transmitter 62). Note that the AC-coupling of the first-protocol receiver 60 will be disabled when using the circuitry of FIG. 14. The first-protocol receiver 60 is DC-coupled on-die and AC-coupling is bypassed on the first-protocol receiver 60.

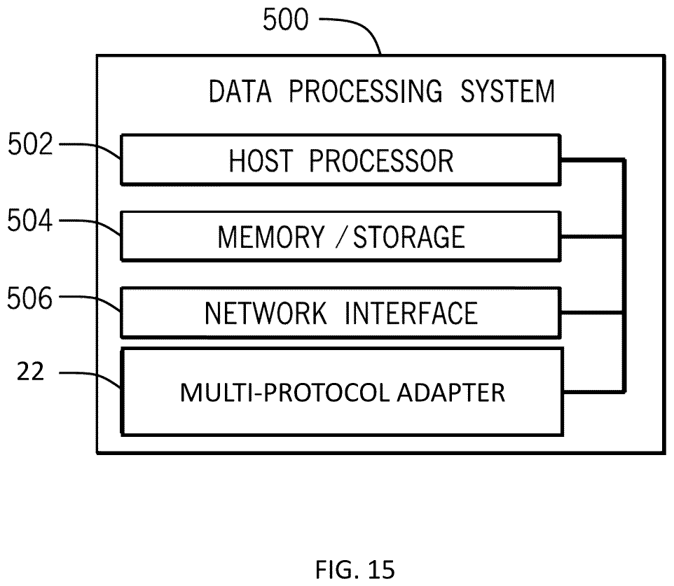

The multi-protocol adapter circuitry 22 may be included in a data processing system, such as a data processing system 500, shown in FIG. 15. This may allow a high-speed transceiver of the data processing system 500 to communicate with a device that uses a lower-power protocol such as M-PHY. The data processing system 500 may include the multi-protocol adapter circuitry 22, a host processor 502, memory and/or storage circuitry 504, and a network interface 506. The data processing system 500 may include more or fewer components (e.g., electronic display, user interface structures, application specific integrated circuits (ASICs)). Moreover, any of the circuit components depicted in FIG. 15 may include the multi-protocol adapter circuitry 22. The host processor 502 may include any of the foregoing processors that may manage a data processing request for the data processing system 500 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 504 may include random access memory (RAM), read-only memory (ROM), one or more hard drives, flash memory, or the like. The memory and/or storage circuitry 504 may hold data to be processed by the data processing system 500. In some cases, the memory and/or storage circuitry 504 may also store configuration programs (e.g., bitstreams, mapping function) for programming the multi-protocol adapter circuitry 22. The network interface 506 may allow the data processing system 500 to communicate with other electronic devices. The data processing system 500 may include several different packages or may be contained within a single package on a single package substrate. For example, components of the data processing system 500 may be located on several different packages at one location (e.g., a data center) or multiple locations. For instance, components of the data processing system 500 may be located in separate geographic locations or areas, such as cities, states, or countries.

The data processing system 500 may be part of a data center that processes a variety of different requests. For instance, the data processing system 500 may receive a data processing request via the network interface 506 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. For example, the multi-protocol adapter circuitry may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112(f).

### EXAMPLE EMBODIMENTS

Example Embodiment 1. An integrated circuit system comprising:
a first transceiver to operate using a first protocol; and
multi-protocol adapter circuitry configurable to enable the first transceiver to be compliant with a second protocol that is a lower-power protocol than the first protocol.

Example Embodiment 2. The integrated circuit system of example embodiment 1, wherein the second protocol comprises MIPI M-PHY.

Example Embodiment 3. The integrated circuit system of example embodiment 1, wherein a receiver of the first transceiver is configurable to oversample a data payload of communication from the second transceiver.

Example Embodiment 4. The integrated circuit system of example embodiment 1, wherein a transmitter of the first transceiver is configurable to generate, for a pulse-width modulation (PWM) signal with a data rate of X megabits per second (Mbps), a Non-Return-to-Zero (NRZ) signal at Y Mbps, wherein Y≥20X.

Example Embodiment 5. The integrated circuit system of example embodiment 1, wherein the multi-protocol adapter circuitry is configurable to select an output impedance from between a lower output impedance and a higher output impedance.

Example Embodiment 6. The integrated circuit system of example embodiment 1, wherein the multi-protocol adapter circuitry is configurable to select an input impedance from among a lower input impedance, a medium input impedance, and a higher input impedance.

Example Embodiment 7. The integrated circuit system of example embodiment 1, wherein the multi-protocol adapter circuitry comprises a bypassable edge converter.

Example Embodiment 8. The integrated circuit system of example embodiment 1, wherein the multi-protocol adapter circuitry comprises a programmable attenuator.

Example Embodiment 9. The integrated circuit system of example embodiment 1, wherein the multi-protocol adapter circuitry is configurable to adjust a common mode voltage of a transmitter of the first transceiver to enable communication with the second transceiver, wherein the second transceiver comprises a 50 ohm to ground termination.

Example Embodiment 10. The integrated circuit system of example embodiment 1, wherein the multi-protocol adapter circuitry is configurable to adjust a common mode voltage of a transmitter of the first transceiver to enable communication with the second transceiver, wherein the second transceiver comprises a 100 ohm differential termination.

Example Embodiment 11. Multi-protocol adapter circuitry comprising:
first input circuitry to input a first input signal from a transmitter of a first transceiver operating according to a higher-power communication protocol;
first output circuitry to output a first output signal based on the first input signal to a receiver of a second transceiver operating according to a lower-power communication protocol; and
protocol adapter circuitry disposed between the first input circuitry and the first output circuitry to comply with the lower-power communication protocol to the receiver of the second transceiver at the first output circuitry.

Example Embodiment 12. The multi-protocol adapter circuitry of example embodiment 11, wherein the protocol adapter circuitry comprises impedance control circuitry to dynamically select an impedance at the first output circuitry to comply with an impedance control specification of the lower-power communication protocol.

Example Embodiment 13. The multi-protocol adapter circuitry of example embodiment 11, wherein the protocol adapter circuitry comprises a bypassable edge converter to comply with a rise or fall time or edge rate specification of the lower-power communication protocol.

Example Embodiment 14. The multi-protocol adapter circuitry of example embodiment 11, wherein the protocol adapter circuitry comprises a programmable attenuator to attenuate the first input signal to transfer common voltage or signal amplitude to comply with a voltage level specification of the lower-power communication protocol.

Example Embodiment 15. The multi-protocol adapter circuitry of example embodiment 11, wherein the protocol adapter circuitry comprises a power splitter or combiner to selectively output the first output signal as a single-ended signal or as a differential signal.

Example Embodiment 16. The multi-protocol adapter circuitry of example embodiment 11, comprising:
second input circuitry to input a second input signal from a transmitter of the second transceiver operating according to the lower-power communication protocol; and
second output circuitry to output a second output signal based on the first input signal to the first receiver operating according to a lower-power communication protocol;
wherein the protocol adapter circuitry is to comply with the lower-power communication protocol to the transmitter of the second transceiver at the second input circuitry.

Example Embodiment 17. The multi-protocol adapter circuitry of example embodiment 16, wherein the protocol adapter circuitry comprises impedance control circuitry to dynamically select an impedance at the second input circuitry to comply with an impedance control specification of the lower-power communication protocol.

Example Embodiment 18. An integrated system comprising:
a first transceiver to operate according to a higher-power protocol;
a second transceiver to operate according to a lower-power protocol; and
protocol adapter circuitry to enable the first transceiver to communicate with the second transceiver in compliance with the lower-power protocol.

Example Embodiment 19. The integrated circuit system of example embodiment 18, wherein:
the first transceiver and the protocol adapter circuitry are disposed on the same die; or
the first transceiver is disposed on a first die in a first package and the protocol adapter circuitry is disposed on a second die in the first package; or
the first transceiver is disposed on a first die in a first package on a first board and the protocol adapter circuitry is disposed on a second die outside of the first package on the first board.

Example Embodiment 20. The integrated circuit system of example embodiment 18, wherein the first transceiver is disposed on a first board, the second transceiver is disposed on a second board, and the protocol adapter circuitry is disposed on the second board.

What is claimed is:

1. An integrated circuit system comprising:
a first transceiver to operate using a first protocol; and
multi-protocol adapter circuitry configurable to enable the first transceiver to be compliant with a second protocol that is a lower-power protocol than the first protocol.

2. The integrated circuit system of claim 1, wherein the second protocol comprises MIPI M-PHY.

3. The integrated circuit system of claim 1, wherein a receiver of the first transceiver is configurable to oversample a data payload of communication from the second transceiver.

4. The integrated circuit system of claim 1, wherein a transmitter of the first transceiver is configurable to generate, for a pulse-width modulation (PWM) signal with a data rate of X megabits per second (Mbps), a Non-Return-to-Zero (NRZ) signal at Y Mbps, wherein Y≥20X.

5. The integrated circuit system of claim 1, wherein the multi-protocol adapter circuitry is configurable to select an output impedance from between a lower output impedance and a higher output impedance.

6. The integrated circuit system of claim 1, wherein the multi-protocol adapter circuitry is configurable to select an input impedance from among a lower input impedance, a medium input impedance, and a higher input impedance.

7. The integrated circuit system of claim 1, wherein the multi-protocol adapter circuitry comprises a bypassable edge converter.

8. The integrated circuit system of claim 1, wherein the multi-protocol adapter circuitry comprises a programmable attenuator.

9. The integrated circuit system of claim 1, wherein the multi-protocol adapter circuitry is configurable to adjust a common mode voltage of a transmitter of the first transceiver to enable communication with the second transceiver, wherein the second transceiver comprises a 50 ohm to ground termination.

10. The integrated circuit system of claim 1, wherein the multi-protocol adapter circuitry is configurable to adjust a common mode voltage of a transmitter of the first transceiver to enable communication with the second transceiver, wherein the second transceiver comprises a 100 ohm differential termination.

11. Multi-protocol adapter circuitry comprising:
first input circuitry to input a first input signal from a transmitter of a first transceiver operating according to a higher-power communication protocol;
first output circuitry to output a first output signal based on the first input signal to a receiver of a second transceiver operating according to a lower-power communication protocol; and
protocol adapter circuitry disposed between the first input circuitry and the first output circuitry to comply with the lower-power communication protocol to the receiver of the second transceiver at the first output circuitry.

12. The multi-protocol adapter circuitry of claim 11, wherein the protocol adapter circuitry comprises impedance control circuitry to dynamically select an impedance at the first output circuitry to comply with an impedance control specification of the lower-power communication protocol.

13. The multi-protocol adapter circuitry of claim 11, wherein the protocol adapter circuitry comprises a bypassable edge converter to comply with a rise or fall time or edge rate specification of the lower-power communication protocol.

14. The multi-protocol adapter circuitry of claim 11, wherein the protocol adapter circuitry comprises a programmable attenuator to attenuate the first input signal to transfer common voltage or signal amplitude to comply with a voltage level specification of the lower-power communication protocol.

15. The multi-protocol adapter circuitry of claim 11, wherein the protocol adapter circuitry comprises a power splitter or combiner to selectively output the first output signal as a single-ended signal or as a differential signal.

16. The multi-protocol adapter circuitry of claim 11, comprising:
second input circuitry to input a second input signal from a transmitter of the second transceiver operating according to the lower-power communication protocol; and
second output circuitry to output a second output signal based on the first input signal to the first receiver operating according to a lower-power communication protocol;
wherein the protocol adapter circuitry is to comply with the lower-power communication protocol to the transmitter of the second transceiver at the second input circuitry.

17. The multi-protocol adapter circuitry of claim 16, wherein the protocol adapter circuitry comprises impedance control circuitry to dynamically select an impedance at the second input circuitry to comply with an impedance control specification of the lower-power communication protocol.

18. An integrated system comprising:
a first transceiver to operate according to a higher-power protocol;
a second transceiver to operate according to a lower-power protocol; and
protocol adapter circuitry to enable the first transceiver to communicate with the second transceiver in compliance with the lower-power protocol.

19. The integrated circuit system of claim 18, wherein:
the first transceiver and the protocol adapter circuitry are disposed on the same die; or
the first transceiver is disposed on a first die in a first package and the protocol adapter circuitry is disposed on a second die in the first package; or
the first transceiver is disposed on a first die in a first package on a first board and the protocol adapter circuitry is disposed on a second die outside of the first package on the first board.

20. The integrated circuit system of claim 18, wherein the first transceiver is disposed on a first board, the second transceiver is disposed on a second board, and the protocol adapter circuitry is disposed on the second board.
